(19) United States
(12) Patent Application Publication
(10) Pub. No.: US 2019/0308067 A1
(43) Pub. Date: Oct. 10, 2019

(54) ORAL-MOTOR PHARYNGEAL MUSCLE EXERCISER

(71) Applicants: Carl Edgar Rohde, II, Litchfield, CT (US); Norma Kalil, Stamford, CT (US); John B. Lee, JR., Ridgefield, CT (US)

(72) Inventors: Carl Edgar Rohde, II, Litchfield, CT (US); Norma Kalil, Stamford, CT (US); John B. Lee, JR., Ridgefield, CT (US)

(21) Appl. No.: 15/945,081

(22) Filed: Apr. 4, 2018

(51) Int. Cl. A63B 23/03; A63B 21/008; A61H 9/00

(52) U.S. Cl. CPC A63B 23/032; A63B 21/0085; A61H 2205/026; A61H 2201/1261; A61H 2201/0103; A61H 9/0085

(57) ABSTRACT

According to some embodiments, an apparatus for oral-motor and oral pharyngeal exercise may include an at least partially flexible, collapsible chamber formed to fit within a patient's mouth. An aperture may be formed in a flexible surface of the collapsible chamber to allow gas to flow into and out of an interior of the collapsible chamber. Moreover, a substantially inflexible wall of the collapsible chamber may be located opposite the aperture. According to some embodiments, the substantially inflexible wall incudes a coupling portion affixed to the flexible surface of the collapsible chamber and having a cleaning opening (e.g., an opening for optional cleaning). A cap portion may be adapted to be removably attached to the coupling portion to seal the interior of the collapsible chamber when attached.

### BACKGROUND

This invention relates generally to an apparatus and method effective to strengthen the pharyngeal wall and material in a patient's mouth, throat, and facial areas.

Muscles that go unused may decline into an atrophied condition. This is true from any muscles in the body (e.g., arm and leg muscles), including muscles in the pharyngeal wall and back-of-throat muscles. As used herein, the term “pharyngeal” may refer to any portion of a patient's pharynx (including the part of the throat behind the mouth and nasal cavity and above the esophagus and the larynx). When these areas are not exercised, the muscles may become flaccid, limp, and/or obstructive. This may create an impediment to eating, swallowing, and/or breathing properly.

Accordingly, it would be desirable to provide a system and method which can effectively strengthen the pharyngeal wall and material in a patient's mouth, throat, and facial areas.

### SUMMARY OF THE INVENTION

According to some embodiments, apparatus, methods, and means may be provided to strengthen the pharyngeal wall and material in a patient's mouth, throat, and facial areas. According to some embodiments, an apparatus for oral-motor and oral pharyngeal exercise may include an at least partially flexible, collapsible chamber formed to fit within a patient's mouth. An aperture may be formed in a flexible surface of the collapsible chamber to allow gas to flow into and out of an interior of the collapsible chamber. Moreover, a substantially inflexible wall of the collapsible chamber may be located opposite the aperture. According to some embodiments, the substantially inflexible wall incudes a coupling portion affixed to the flexible surface of the collapsible chamber and having a cleaning opening (e.g., an opening for optional cleaning). A cap portion may be adapted to be removably attached to the coupling portion to seal the interior of the collapsible chamber when attached.

Some embodiments comprise: inserting the oral-motor pharyngeal exerciser into a patient's mouth, wherein the exerciser includes: (i) an at least partially flexible, collapsible chamber formed to fit within a patient's mouth, (ii) an aperture formed in a flexible surface of the collapsible chamber, wherein the aperture allows gas to flow into and out of an interior of the collapsible chamber, and (iii) a substantially inflexible wall of the collapsible chamber located opposite the aperture; means for providing an independent source of negative pressure that draws gases out of the exerciser thereby creating an increase in resistive force; and means for maintaining the negative pressure for up to 10 minutes per session.

A technical effect of some embodiments of the invention is a greatly improved way to strengthen and tone the muscles (the superior constrictor muscle, middle constrictor muscle, and the inferior constrictor muscle) and organic material directly related to the oral cavity (soft palate, tongue, oropharynx, laryngopharynx, and epiglottis) thereby significantly improving the function of all forms of breathing, mouth articulation, tongue, throat and facial areas. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is an overview of an oral-motor pharyngeal muscle exerciser according to some embodiments of the present invention.

FIG. 2 illustrates an exerciser with a collapsed chamber in accordance with some embodiments.

FIG. 3 illustrates an exerciser with a detached cap portion according to some embodiments.

FIG. 4 is a more detailed view of an exerciser with a detached cap portion in accordance with some embodiments.

FIG. 5 illustrates a method of using an oral-motor pharyngeal muscle exerciser according to some embodiments of the present invention.

FIG. 6 is an overview of an oral-motor pharyngeal muscle exerciser in accordance with another embodiment of the present invention.

### DETAILED DESCRIPTION

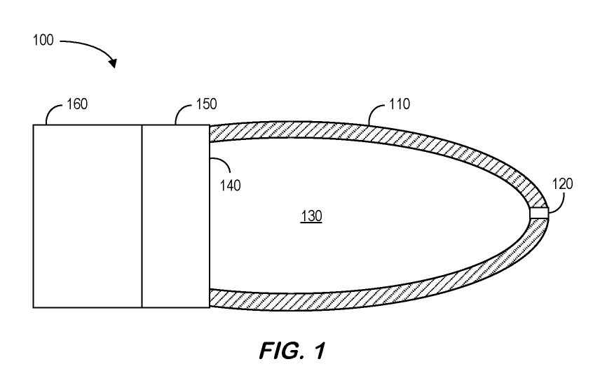

Some embodiments described herein may provide an “oral gym” such that a patient may directly target and engage the oral pharyngeal muscles in an exercise regimen designed to strengthen and maintain the musculature over extended periods of time. FIG. 1 is an overview of an oral-motor pharyngeal muscle exerciser 100 according to some embodiments of the present invention. The exerciser 100 includes an at least partially flexible, collapsible chamber 110 formed to fit within a patient's mouth. According to some embodiments, the flexible surface of the collapsible chamber is formed of medical quality silicone. An aperture 120 formed in a flexible surface of the collapsible chamber 110 may allow gas to flow into and out of an interior 130 of the collapsible chamber 110. Moreover, a substantially inflexible wall 140 of the collapsible chamber 110 may be located opposite the aperture 120 to seal that side of the interior 130.

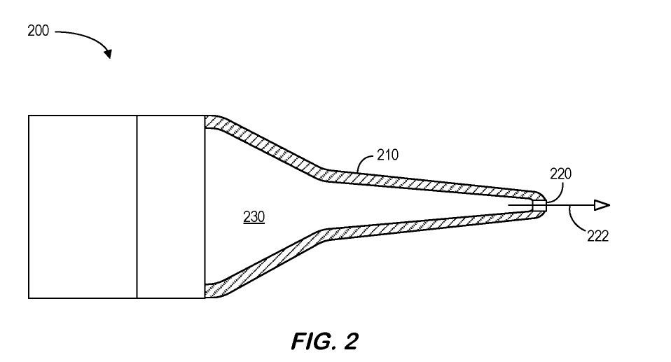

The exerciser 100 may be placed into a patient's mouth, and he or she may use pharyngeal muscles to withdraw air from the interior 130 via the aperture 120 and thereby collapse the chamber 110. For example, FIG. 2 illustrates an exerciser 200 with a collapsed chamber 210 in accordance with some embodiments. As can be seen, the patient has withdrawn air from the interior 230 via the aperture 220 (as illustrated by the arrow 222 in FIG. 2). When the patient stops “pulling” with his or her pharyngeal muscles, air will re-enter the interior 230 via the aperture 220 and the chamber 210 will automatically return to a non-collapsed shape.

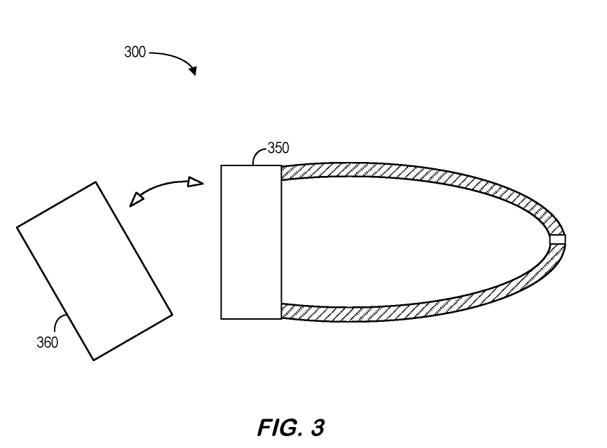

Referring again to FIG. 1, according to some embodiments the substantially inflexible wall 140 incudes a coupling portion 150 affixed to the flexible surface of the collapsible chamber 110. A cap portion 160 may be adapted to be removably attached to the coupling portion 150 to seal the interior 130 of the collapsible chamber 110 when attached. For example, FIG. 3 illustrates an exerciser 300 with a cap portion 360 detached from the coupling portion 350 according to some embodiments. The cap portion 360 and coupling portion 350 may be configured to be attached and detached from each other (as illustrated by the arrow in FIG. 3). For example, according to some embodiments the cap portion 360 may be adapted to screw onto and off of the coupling portion 350 to seal the device.

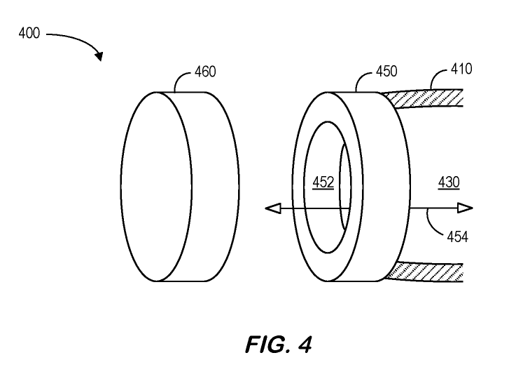

According to some embodiments, the coupling portion 350 may include a “cleaning” opening. For example, FIG. 4 is a more detailed view of an exerciser 400 with a detached cap portion 460 and coupling portion 450 in accordance with some embodiments. As can be seen, the coupling portion 450 has a cleaning opening 452 through which a person may insert soapy water, a disinfectant, a cleaning brush (e.g., to clean the interior 430 and/or inner surface of the collapsible chamber 410), etc. as illustrated by the arrow 454 in FIG. 4. Note that an inner wall of the cleaning opening 452 might be adapted with thread screws, a rubber gasket, etc. to provide an airtight seal when attached to the cap portion 460.

Thus, embodiments may comprise a closed-end medical quality silicone tube with a small aperture at its tip. Moreover, the exerciser may be capped by a hard-plastic cap that twists onto and off of a coupling portion to seal the tube. The tube mouthpiece may create a resistive force as air is drawn out of the interior of the tube. Note that the resistive force may be increased or decreased based on the force of the pull of the patient's throat muscles. Moreover, the tube may automatically resume a non-collapsed configuration when the patient stops withdrawing air (that is, air re-enters the tube via the aperture).

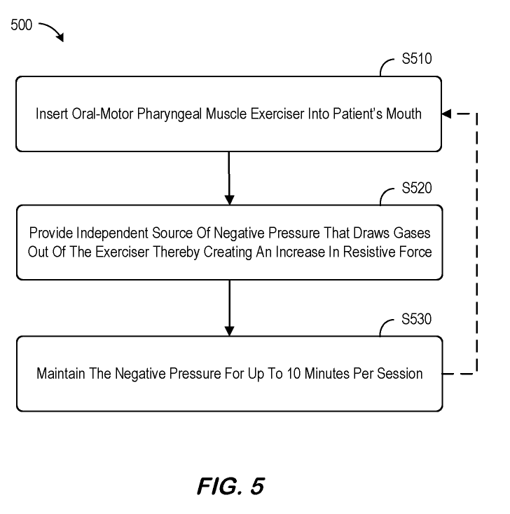

FIG. 5 illustrates a method 500 of using an oral-motor pharyngeal muscle exerciser according to some embodiments of the present invention. At S510, a person may insert the oral-motor pharyngeal exerciser into a patient's mouth. As described herein, the exerciser may include: (i) an at least partially flexible, collapsible chamber formed to fit within a patient's mouth, (ii) an aperture formed in a flexible surface of the collapsible chamber, wherein the aperture allows gas to flow into and out of an interior of the collapsible chamber, and (iii) a substantially inflexible wall of the collapsible chamber located opposite the aperture. At S520, an independent source of negative pressure may be provided to draw gases out of the exerciser and thereby create an increase in resistive force. At S530, the patient may maintain the negative pressure from one to five minutes and the process may be repeated as desired (as illustrated by the dashed arrow in FIG. 5). For example, the process might be repeated by the patient twice a day (e.g., once in the morning and once at night). Moreover, the process may be performed for a one month period of time (or longer) to improve breathing, chewing, articulation, etc.

Thus, embodiments described herein may exercise oral-pharyngeal muscles. Moreover, the exerciser may ameliorate muscle imbalance in the oral-pharyngeal area.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

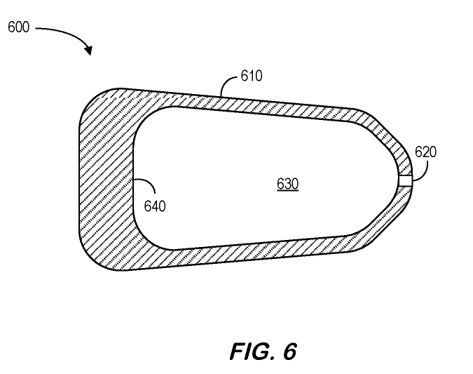

Although specific configurations have been described herein, note that any number of other configurations may be provided in accordance with embodiments of the present invention (e.g., shapes other than those illustrated might be used for the exerciser). For example, FIG. 6 is an overview of an oral-motor pharyngeal muscle exerciser 600 in accordance with another embodiment of the present invention. As before, the exerciser 600 includes a collapsible chamber 610 with a flexible wall that has an aperture 620 opposite a substantially inflexible wall 640. In this case, the substantially inflexible wall 640 may be associated with a thicker surface as compared to other portions of the chamber 610. In this way, the substantially inflexible wall 640 may provide some resistance when air is withdrawn from the interior 630. Note that in this embodiment, no separate coupling portion or cap portion is required.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An apparatus for oral-motor and oral pharyngeal exercise, comprising:
an at least partially flexible, collapsible chamber formed to fit within a patient's mouth;
an aperture formed in a flexible surface of the collapsible chamber, wherein the aperture allows gas to flow into and out of an interior of the collapsible chamber; and
a substantially inflexible wall of the collapsible chamber located opposite the aperture.

2. The apparatus of claim 1, wherein the substantially inflexible wall incudes:
a coupling portion affixed to the flexible surface of the collapsible chamber and having a cleaning opening.

3. The apparatus of claim 2, further comprising:
a cap portion adapted to be removably attached to the coupling portion to seal the interior of the collapsible chamber when attached.

4. The apparatus of claim 3, wherein the cap portion is adapted to screw onto and off of the coupling portion.

5. The apparatus of claim 1, wherein the flexible surface of the collapsible chamber is formed of medical quality silicone.

6. A method of using an oral-motor pharyngeal exerciser, comprising:
inserting the oral-motor pharyngeal exerciser into a patient's mouth, wherein the exerciser includes: (i) an at least partially flexible, collapsible chamber formed to fit within a patient's mouth, (ii) an aperture formed in a flexible surface of the collapsible chamber, wherein the aperture allows gas to flow into and out of an interior of the collapsible chamber, and (iii) a substantially inflexible wall of the collapsible chamber located opposite the aperture;
providing an independent source of negative pressure that draws gases out of the exerciser thereby creating an increase in resistive force; and
maintaining the negative pressure for up to 10 minutes per session.

7. The method of claim 6, wherein said maintaining is repeated by the patient twice a day.

8. The method of claim 7, wherein said maintaining is performed at least once in the morning and at least once at night.

9. The method of claim 8, wherein said maintaining is performed for a one month period of time or longer.

10. The method of claim 6, wherein the substantially inflexible wall incudes a coupling portion affixed to the flexible surface of the collapsible chamber and having a cleaning opening.

11. The method of claim 10, wherein the exerciser further includes a cap portion adapted to be removably attached to the coupling portion to seal the interior of the collapsible chamber when attached.

12. The method of claim 11, wherein the cap portion is adapted to screw onto and off of the coupling portion.

13. The method of claim 6, wherein the flexible surface of the collapsible chamber is formed of medical quality silicone.
